(19) United States
(12) Patent Application Publication
(10) Pub. No.: US 2024/0326650 A1
(43) Pub. Date: Oct. 3, 2024

(54) SYSTEMS AND METHODS FOR EN ROUTE PROACTIVE THERMAL CONDITIONING OF ELECTRIFIED VEHICLE BATTERIES TO REDUCE CHARGING AND STOPPAGE TIME

(71) Applicant: FCA US LLC, Auburn Hills, MI (US)

(72) Inventors: Ali Sina Shojaei, Birmingham, MI (US); Kamal Bouyoucef, Rochester Hills, MI (US); Feisel Weslati, Troy, MI (US)

(21) Appl. No.: 18/192,924

(22) Filed: Mar. 30, 2023

(51) Int. Cl. B60L 58/24; B60L 53/64; B60L 53/66; B60L 58/12

(52) U.S. Cl. CPC B60L 58/24; B60L 53/64; B60L 53/66; B60L 58/12

(57) ABSTRACT

Charging session optimization systems and methods for an electrified vehicle involve determining a target roadside charging station intended to be used for a future charging session to recharge a high voltage battery system of the electrified vehicle, receiving a set of real-time charging information including at least a temperature and a state of charge (SOC) of the high voltage battery system, and thermally preconditioning the high voltage battery system during a period up until the future charging session begins based on at least the temperature and the SOC of the high voltage battery system, wherein the thermal preconditioning of the high voltage battery system is performed such that its future temperature and future SOC at an end of the period when the future charging session begins are each within predetermined ranges associated with an optimal rate of recharging.

### FIELD

The present application generally relates to electrified vehicles (EVs) and, more particularly, to systems and methods for en route proactive thermal conditioning of EV batteries to reduce charging and stoppage time.

### BACKGROUND

Some electrified vehicles (battery electric vehicles (BEVs), plug-in hybrid electric vehicles (PHEVs), etc.) are capable of charging their high voltage battery system (e.g., a traction battery system for powering one or more electric motors) using roadside charging stations. Current parameters of the battery systems (temperature, state-of-charge (SOC), etc.) affect a rate at which the battery systems are able to receive charge (e.g., a fast-charging mode vs. a slower conditioning charging mode). These roadside charging stations may also vary in their charge provision abilities (power ratings). Thus, most charging sessions by electrified vehicles via roadside charging stations end up being less efficient than an optimal efficiency, which increases charging time/costs and also creates a barrier of entry/acceptance for electrified vehicles. Accordingly, while such conventional electrified vehicle charging techniques do work well for their intended purpose, there exists an opportunity for improvement in the relevant art.

### SUMMARY

According to one example aspect of the invention, a charging session optimization system for an electrified vehicle is presented. In one exemplary implementation, the charging session optimization system comprises a set of battery system sensors configured to monitor a high voltage battery system of the electrified vehicle to determine at least its temperature and its state of charge (SOC), wherein the temperature and SOC of the high voltage battery system are part of a set of real-time charging information and a controller configured to determine a target roadside charging station intended to be used for a future charging session to recharge the high voltage battery system, and, based on at least the temperature and the SOC of the high voltage battery system, thermally preconditioning the high voltage battery system during a period up until the future charging session begins, wherein the thermal preconditioning of the high voltage battery system is performed such that its future temperature and future SOC at an end of the period when the future charging session begins are each within predetermined ranges associated with an optimal rate of recharging.

In some implementations, the controller is configured to perform thermal preconditioning of the high voltage battery system by adjusting operation of an electrified powertrain comprising one or more electric motors powered by the high voltage battery system. In some implementations, the controller is configured to perform thermal preconditioning of the high voltage battery system by controlling a thermal management system of the electrified vehicle that is configured to heat/cool the high voltage battery system.

In some implementations, the controller is configured to consider cost savings versus energy consumption in the thermal preconditioning of the high voltage battery system. In some implementations, the controller is further configured to determine a set of a prior information relating to the upcoming charging session. In some implementations, the set of a priori information includes at least one of climate conditions, distance, duration, estimated time of arrival, average and instantaneous vehicle speed, traffic information, and road gradient. In some implementations, the set of a priori information includes at least one of past behavior of a current operator of the electrified vehicle and past behavior of a same or similar type of the electrified vehicle by one or more other operators.

In some implementations, the controller is further configured to determine a set of charging station parameters for the target charging station, and wherein the thermal preconditioning of the high voltage battery system is further based on the set of charging station parameters. In some implementations, the set of charging station parameters includes at least one of a power rating of the target charging station, an expected availability of the target charging station at a time of arrival, and availability of an external thermal battery conditioning system for the electrified vehicle. In some implementations, the controller determines the set of charging station parameters from the target charging station via a vehicle-to-everything (V2X) communication system.

According to another example aspect of the invention, a charging session optimization method for an electrified vehicle is presented. In one exemplary implementation, the charging session optimization method comprises determining, by a controller of the electrified vehicle, a target roadside charging station intended to be used for a future charging session to recharge a high voltage battery system of the electrified vehicle, receiving, by the controller and from a set of battery system sensors, a set of real-time charging information including at least a temperature and a SOC of the high voltage battery system determined by set of battery system sensors by monitoring the high voltage battery system, and thermally preconditioning, by the controller, the high voltage battery system during a period up until the future charging session begins based on at least the temperature and the SOC of the high voltage battery system, wherein the thermal preconditioning of the high voltage battery system is performed such that its future temperature and future SOC at an end of the period when the future charging session begins are each within predetermined ranges associated with an optimal rate of recharging.

In some implementations, the thermal preconditioning of the high voltage battery system includes adjusting, by the controller, operation of an electrified powertrain comprising one or more electric motors powered by the high voltage battery system. In some implementations, the thermal preconditioning of the high voltage battery system includes controlling, by the controller, a thermal management system of the electrified vehicle that is configured to heat/cool the high voltage battery system.

In some implementations, the controller is configured to consider cost savings versus energy consumption in the thermal preconditioning of the high voltage battery system. In some implementations, the method further comprises determining, by the controller, a set of a prior information relating to the upcoming charging session and utilizing, by the controller, the set of a priori information in the thermal preconditioning of the high voltage battery system. In some implementations, wherein the set of a priori information includes at least one of climate conditions, distance, duration, estimated time of arrival, average and instantaneous vehicle speed, traffic information, and road gradient. In some implementations, the set of a priori information includes at least one of past behavior of a current operator of the electrified vehicle and past behavior of a same or similar type of the electrified vehicle by one or more other operators.

In some implementations, the method further comprises determining, by the controller, a set of charging station parameters for the target charging station, wherein the thermal preconditioning of the high voltage battery system is further based on the set of charging station parameters. In some implementations, the set of charging station parameters includes at least one of a power rating of the target charging station, an expected availability of the target charging station at a time of arrival, and availability of an external thermal battery conditioning system for the electrified vehicle. In some implementations, the controller determines the set of charging station parameters from the target charging station via a V2X communication system.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having an example charging session optimization system according to the principles of the present application;

FIG. 2 is a functional block diagram of an example charging session optimization architecture according to the principles of the present application; and

FIG. 3 is a flow diagram of an example charging session optimization method for an electrified vehicle according to the principles of the present application.

### DESCRIPTION

As discussed above, most charging sessions by electrified vehicles via roadside charging stations end up being less efficient than an optimal efficiency, which increases charging time/costs and also creates a barrier of entry/acceptance for electrified vehicles. Fast charging is a key performance metric of modern electrified vehicles. To achieve fast charging, the battery system(s) should be within the optimum temperature range throughout the charging event. For typical, commercial lithium ion (Li-lon) battery cells, maximum charge speed is achieved in the cell temperature range of approximately 25 degrees Celsius (° C.) to 55° C. and/or state of charge (SOC) in a predefined range. This means that if the battery system is cold, it should be heated to an optimal temperature, and continuously cooled thereafter to avoid extreme temperatures. If the battery system is not in the optimum temperature range at the beginning of the charging session, the duration of charging session will be negatively impacted. Therefore, to enable fastest possible charging session, the battery system should be conditioned prior to plugging to the charging station. As a result, improved techniques that proactively thermally condition the electrified vehicle's battery systems en route to a charging station are presented.

These techniques include heating or cooling the battery system(s) via appropriate methods, such as varying operating conditions of the electrified powertrain. A large variety of real-time and/or a priori (past) or historical information could be taken into account in determining a maximum possible cost saving (versus energy consumption) to a particular thermal conditioning strategy. In addition to current battery system parameters (temperature, state of charge (SOC), etc.) and charging station power ratings and current/expected availability, other non-limiting examples include climate conditions, distance, duration, estimated time of arrival, average/instantaneous speed, traffic information, road gradient, and same/similar vehicle past behavior. The aim of these techniques is to enabling the fastest possible charging and shortest possible total stoppage time for any electrified vehicle at a forthcoming charging station by applying proactive battery thermal management prior to the vehicle's arrival.

The objectives of the present techniques are be achieved by predicting the temperature and the state of charge (SOC) of the battery within the time horizon of the trip towards the charging station and ensuring that the battery temperature at arrival is at optimum level. Additionally, this functionality can ensure maximum cost saving and optimum total energy consumption. For example, the functionality can include predicting the energy consumption associated to any chosen battery heating or cooling strategy that may be applied prior to arriving at a charging station. Additionally, the functionality can include predicting the duration of a forthcoming charging event and total stoppage time. As mentioned, this functionality utilizes a host of real-time and/or a priori information about the trip as listed above. In addition, the functionality can make use of historical travel data from the present driver and/or other drivers, related to the same vehicle or other similar vehicles (e.g., vehicle types/models).

Additionally, the functionality can make use of real-time or a priori information about the charging station, including but not limited to, the power rating of the charging station, forecasted availability of the charging station at the time of arrival, and availability of external cooling or heating apparatus. Additionally, the functionality can make use of real-time or a priori other information about the battery including but not limited to, the state of health (SOH) and battery characteristics such as the thermal, electrical, and mechanical characteristics (current, voltage, capacity, etc.), and heat generation or heat retention of the vehicle's components. Additionally, the functionality can make use of a priori information about the electrified vehicle's battery thermal management system including, but not limited to, its cooling and heating capacity and any thermal energy re-distribution capability. Additionally, the functionality can make use of a priori information about the trip that follows the charging session including, but not limited to duration, average/maximum speed, and road gradient.

In contrast to the techniques of the present application, conventional electrified vehicle battery charging systems and methods utilize a pre-defined battery temperature set point. When the location of a charging station is selected, such as a destination on a navigation system, the battery thermal management system of the electrified vehicle is activated to achieve this pre-defined setpoint by the arrival time. A plurality of drawbacks can be identified for these conventional solutions. First, the battery temperature setpoint used for conditioning the battery when arriving at the charging station is pre-defined and it does not adapt to real-time and historical information about the trip, or driving patterns, or availability of the charging station at the time of arrival.

Next, the existing solutions ignore the minimization of the total duration of charging since they effectively only maximize the charge acceptancy of the battery at the start of charging without considering maximization of charge acceptancy for the entire duration of the charging event. Next, the existing solutions ignore minimization of the total stoppage time since they do not consider the impact of battery temperature at the start of charging on the final battery temperature at the end of charging. Next, the existing solutions are not sensitive to variation in charge acceptance of the battery at different SOC levels. This means that in the current solutions thermal conditioning of the battery will proceed regardless of whether the battery can accept fast charging in the SOC range that the charging will occur. Next, the existing solutions are do not minimize the total energy consumption or the total cost of the applied thermal management strategy. Finally, the existing solutions to not consider availability of the charging station at the time of arrival therefore the function is activated regardless of whether charging can start at the time of arrival, or charging will be delayed due to unavailability of the charging station.

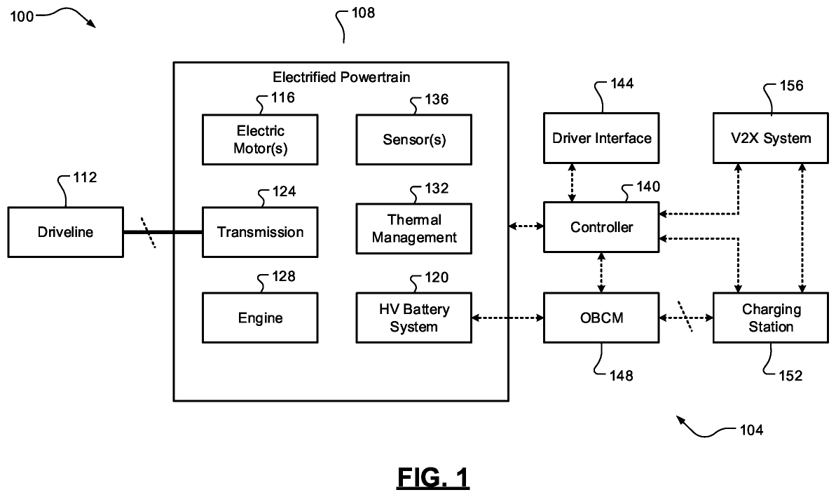

Referring now to FIG. 1, a functional block diagram of an electrified vehicle 100 having an example charging session optimization system 104 according to the principles of the present application is illustrated. The electrified vehicle 100 is any suitable type of electrified vehicle capable of recharging its battery system(s) via a charging station, including a battery electric vehicle (BEV), a plug-in hybrid electric vehicle (PHEV), and the like. An electrified powertrain 108 is configured to generate and transfer drive torque to a driveline 112 for vehicle propulsion. The electrified powertrain 108 includes one or more electric motors 116 powered by a high voltage (HV) battery system 120. The electric motors 116 generate the drive torque, which is transferred to the driveline 112 via a transmission 124. An optional internal combustion engine 128 is also configured to generate mechanical energy by combustion of an air/fuel mixture. This mechanical energy could be utilized for drive torque (to the driveline 112 via the transmission 124) and/or to act as a generator by conversion to electrical energy (e.g., for recharging the HV battery system 120). A thermal management system 132 is configured to heat/cool the HV battery system 120. The thermal management system 132 could have any suitable heating/cooling devices such as, but not limited to, air cooling devices (fans, fins, etc.) and liquid-cooled devices (e.g., water or refrigerant based cooling lines).

A set of sensors 136 measure operating parameters of the electrified vehicle 100 including, but not limited to, parameters of the HV battery system 120. These parameters include current, voltage, temperature, and the like, and the sensors 136 could directly or indirectly monitor SOC, SOH, and other battery system parameters. A controller 140 controls operation of the electrified vehicle 100 and, in particular, the electrified powertrain 108, such that the electrified powertrain 108 satisfies a torque request from a customer/operator via a driver interface 144 (e.g., an accelerator pedal). The electrified vehicle 100 also includes an on-board charging module (OBCM) 148 or similar charging controller for interaction with an external (e.g., roadside) charging station 152. An optional vehicle-to-everything (V2X) communication system 156 could be utilized by the controller 136 for communication with a remote charging station 152. The controller 136 is configured to implement at least a portion of the techniques of the present application. Alternatively, a part of the functionality could be implemented in a cloud-based computation system (e.g., a remote server) with which the controller 136 will be in communication via a suitable network (e.g., a cellular network).

The functionality described in the present application determines and activates the optimum thermal management strategy that can be applied prior to arriving at a fast-charging station that ensures fastest possible charging and minimum total stoppage time at the charging station. The functionality determines the optimum thermal management strategy in real-time by making use of a host of information including, but not limited to, information about the trip towards the charging station, driving data, climate conditions, charging station conditions, vehicle thermal systems capabilities, conditions of the charging station, information about the onward trip following charging. Rather than using pre-defined temperature setpoints as in the conventional solutions, the battery thermal management strategy of the present application is determined in real-time and adapts to the real-time and historical information about the vehicle trip, driving patterns and information about the conditions of the charging station. Hence, the functionality defined in the present application determines provides the best possible result for the specific scenario at hand.

Contrary to the conventional or existing solutions, the proposed solution of the present application: (i) maximizes the charge acceptancy of the battery for the entire duration of the charging event hence minimizing the total duration of charging; (ii) minimizes the total stoppage time by considering the impact of the battery thermal management strategy chosen before arriving at the charger on the final battery temperature at the end of charging (minimizes the possibility of experiencing battery overheating due to high initial temperature); (iii) accounts for SOC range of charging and determines if the total duration of charging can be improved by way of thermal management (if the total duration of charging is limited due to the SOC range of charging the proposed functionality will adapt accordingly to avoid unnecessary battery thermal conditioning); (iv) minimizes the total energy consumption and the total cost of the applied thermal management strategy; and (v) considers the availability of charger at the time of arrival and adapts to the actual time that the charging can be started.

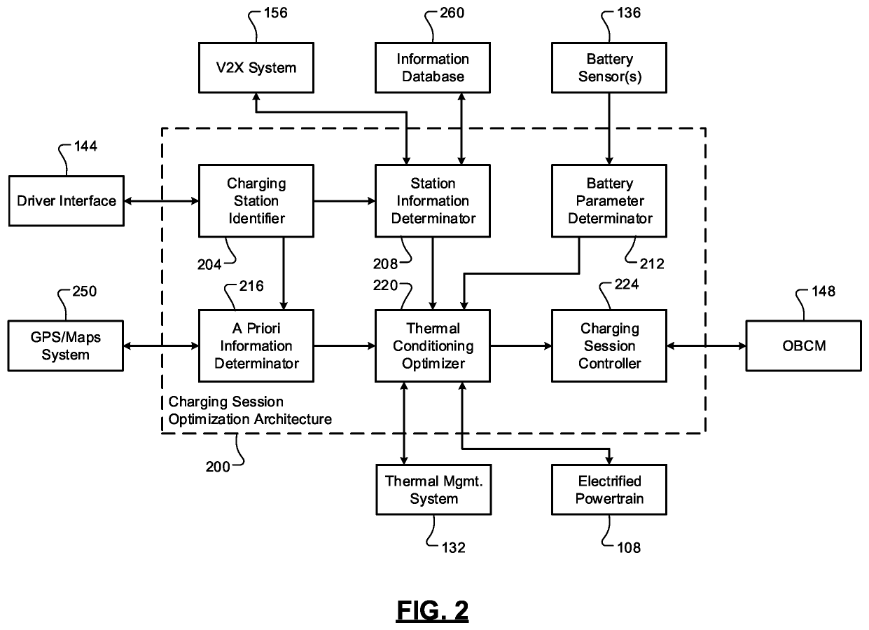

Referring now to FIG. 2, a functional block diagram of an example charging session optimization architecture 200 according to the principles of the present application is illustrated. The architecture 200 generally comprises a charging station identifier 204, a station information determinator 208, a battery parameter determinator 212, an a prior information determinator 216, a thermal conditioning optimizer 220, and a charging session controller 224. The charging station identifier 204 identifies the target charging station, such as based on driver or operator input via the driver interface 144. The station information determinator 208 determines information about the target charging station as previously discussed herein, such as via V2X communication using a V2X system 156 and/or from an information database 260. The battery parameter determinator determines the necessary parameters for the high voltage battery system 120 as previously discussed herein (temperature, SOC, etc.) based on measurements from the battery sensor(s) 136. An a prior information determinator 216 also determines a priori information as previously discussed herein based on the target charging station and location information, such as from a global positioning satellite (GPS) and/or maps system 250. All of this gathered/determined information is fed to the thermal conditioning optimizer 220, which determines and executes an optimal thermal preconditioning strategy for the electrified powertrain 108 and/or the thermal management system 132 to prepare the high voltage battery system 120 for an upcoming charging session. Finally, the charging session controller 224 executes charging session, such as in coordination with the OBCM 148.

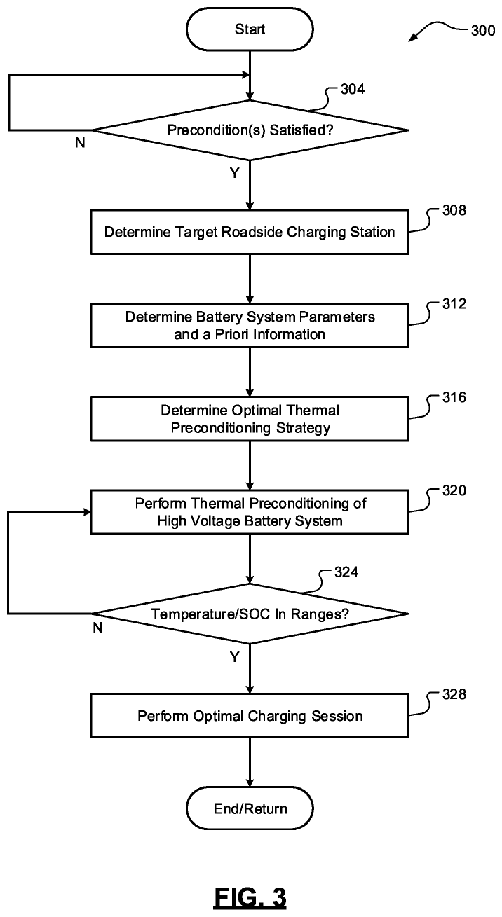

Referring now to FIG. 3, a flow diagram of an example charging session optimization method 300 for an electrified vehicle according to the principles of the present application is illustrated. While the description of the method 300 references the electrified vehicle 100 and its components for illustrative/explanatory purposes, it will be appreciated that the method 300 could be applicable to any suitable electrified vehicle capable of recharging its battery system(s) via a roadside charging station. At 304, the controller 140 determines whether a set of one or more preconditions are satisfied. This could include, for example only, a target charging station having been selected or otherwise identified by an operator or driver of the electrified vehicle 100 and there being no outstanding malfunctions or faults that would otherwise inhibit the operation of the charging session optimization techniques. When false, the method 300 ends or returns to 304. When true, the method 300 proceeds to 308. At 308, the controller 140 determines the target roadside charging station intended to be used for the future charging session to recharge the high voltage battery system 120 (and possibly, parameters/criteria relating to the target charging station), such as via V2X communication using the V2X system 156. At 312, the controller 140 receives, from the set of sensors 136, a set of real-time charging information including at least a temperature and a state of charge (SOC) of the high voltage battery system 120.

As previously mentioned, this information could be determined by the sensor(s) 136, could be modeled/determined by the controller 140 based on other measured parameters (current, voltage, etc.), or some combination thereof. In addition to the real-time parameters of the high voltage battery system 120, a variety of a priori information could be taken into account as previously discussed herein. At 316, the controller 140 determines an optimal thermal preconditioning strategy for the high voltage battery system 140 based on all of the various criteria previously discussed herein. As previously discussed, this could include a cost savings versus energy consumption analysis. At 320, the controller 140 performs/controls thermally preconditioning of the high voltage battery system 120 during a period up until the future charging session begins (see decision step 324) based on at least the temperature and the SOC of the high voltage battery system 120. As previously discussed, this could include adjusting operation of an electrified powertrain 108 and/or controlling the thermal management system 132. At 324, corresponding to the end of the period and when the charging session begins at 328, the final temperature and final SOC of the battery system are each within predetermined ranges associated with an optimal rate of recharging. The method 300 then ends or returns to 304 for one or more additional cycles.

It will be appreciated that the term “controller” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A charging session optimization system for an electrified vehicle, the charging session optimization system comprising:
a set of battery system sensors configured to monitor a high voltage battery system of the electrified vehicle to determine at least its temperature and its state of charge (SOC), wherein the temperature and SOC of the high voltage battery system are part of a set of real-time charging information; and
a controller configured to:
determine a target roadside charging station intended to be used for a future charging session to recharge the high voltage battery system; and
based on at least the temperature and the SOC of the high voltage battery system, thermally preconditioning the high voltage battery system during a period up until the future charging session begins,
wherein the thermal preconditioning of the high voltage battery system is performed such that its future temperature and future SOC at an end of the period when the future charging session begins are each within predetermined ranges associated with an optimal rate of recharging.

2. The charging optimization system of claim 1, wherein the controller is configured to perform thermal preconditioning of the high voltage battery system by adjusting operation of an electrified powertrain comprising one or more electric motors powered by the high voltage battery system.

3. The charging session optimization system of claim 2, wherein the controller is configured to perform thermal preconditioning of the high voltage battery system by controlling a thermal management system of the electrified vehicle that is configured to heat/cool the high voltage battery system.

4. The charging session optimization system of claim 1, wherein the controller is configured to consider cost savings versus energy consumption in the thermal preconditioning of the high voltage battery system.

5. The charging session optimization system of claim 1, wherein the controller is further configured to determine a set of a prior information relating to the upcoming charging session.

6. The charging session optimization system of claim 5, wherein the set of a priori information includes at least one of climate conditions, distance, duration, estimated time of arrival, average and instantaneous vehicle speed, traffic information, and road gradient.

7. The charging session optimization system of claim 6, wherein the set of a priori information includes at least one of past behavior of a current operator of the electrified vehicle and past behavior of a same or similar type of the electrified vehicle by one or more other operators.

8. The charging session optimization system of claim 1, wherein the controller is further configured to determine a set of charging station parameters for the target charging station, and wherein the thermal preconditioning of the high voltage battery system is further based on the set of charging station parameters.

9. The charging session optimization system of claim 8, wherein the set of charging station parameters includes at least one of a power rating of the target charging station, an expected availability of the target charging station at a time of arrival, and availability of an external thermal battery conditioning system for the electrified vehicle.

10. The charging session optimization system of claim 8, wherein the controller determines the set of charging station parameters from the target charging station via a vehicle-to-everything (V2X) communication system.

11. A charging session optimization method for an electrified vehicle, the charging session optimization method comprising:
determining, by a controller of the electrified vehicle, a target roadside charging station intended to be used for a future charging session to recharge a high voltage battery system of the electrified vehicle;
receiving, by the controller and from a set of battery system sensors, a set of real-time charging information including at least a temperature and a state of charge (SOC) of the high voltage battery system determined by set of battery system sensors by monitoring the high voltage battery system; and
thermally preconditioning, by the controller, the high voltage battery system during a period up until the future charging session begins based on at least the temperature and the SOC of the high voltage battery system,
wherein the thermal preconditioning of the high voltage battery system is performed such that its future temperature and future SOC at an end of the period when the future charging session begins are each within predetermined ranges associated with an optimal rate of recharging.

12. The charging optimization method of claim 11, wherein the thermal preconditioning of the high voltage battery system includes adjusting, by the controller, operation of an electrified powertrain comprising one or more electric motors powered by the high voltage battery system.

13. The charging session optimization method of claim 12, wherein the thermal preconditioning of the high voltage battery system includes controlling, by the controller, a thermal management system of the electrified vehicle that is configured to heat/cool the high voltage battery system.

14. The charging session optimization method of claim 11, wherein the controller is configured to consider cost savings versus energy consumption in the thermal preconditioning of the high voltage battery system.

15. The charging session optimization method of claim 11, further comprising determining, by the controller, a set of a prior information relating to the upcoming charging session and utilizing, by the controller, the set of a priori information in the thermal preconditioning of the high voltage battery system.

16. The charging session optimization method of claim 15, wherein the set of a priori information includes at least one of climate conditions, distance, duration, estimated time of arrival, average and instantaneous vehicle speed, traffic information, and road gradient.

17. The charging session optimization method of claim 16, wherein the set of a priori information includes at least one of past behavior of a current operator of the electrified vehicle and past behavior of a same or similar type of the electrified vehicle by one or more other operators.

18. The charging session optimization method of claim 11, further comprising determining, by the controller, a set of charging station parameters for the target charging station, wherein the thermal preconditioning of the high voltage battery system is further based on the set of charging station parameters.

19. The charging session optimization method of claim 18, wherein the set of charging station parameters includes at least one of a power rating of the target charging station, an expected availability of the target charging station at a time of arrival, and availability of an external thermal battery conditioning system for the electrified vehicle.

20. The charging session optimization method of claim 18, wherein the controller determines the set of charging station parameters from the target charging station via a vehicle-to-everything (V2X) communication system.
